(19) United States
(12) Patent Application Publication
(10) Pub. No.: US 2026/0243906 A1
(43) Pub. Date: Aug. 20, 2026

(54) INTERFERENCE-PROOF RADIATION DETECTOR

(71) Applicant: ARKTIS RADIATION DETECTORS LTD., Zürich (CH)

(72) Inventors: Ulisse GENDOTTI, Zürich (CH); Rico CHANDRASEKHARAN, Zürich (CH); Christian HELD, Zürich (CH)

(21) Appl. No.: 19/161,492

(22) PCT Filed: Mar. 1, 2024
(86) PCT No.: PCT/EP2024/055477

§ 371 Date: Sep. 2, 2025

(30) Foreign Application Priority Data
Mar. 3, 2023 (CH) CH000226/2023

(51) Int. Cl. G01T 1/20; G01T 3/06; G01V 5/22

(52) U.S. Cl. CPC G01T 1/20182; G01T 3/06; G01V 5/22

(57) ABSTRACT

An interference-proof radiation detector (10, 11a, 11b) is described, comprising a plurality of detector subunits, each comprising a scintillator (111a, 111b) and two or more continuously operable, solid-state silicon photomultiplier sensors configured to generate a detection signal responsive to scintillation light, the radiation detector further comprising a signal processing circuit (15) connected to the silicon photomultiplier sensors and being configured to: in case a detection signal of the first detector subunit exceeds a first signal amplitude threshold defined by the signal processing circuit: determine an overshoot time span during which the detection signal is above the first signal amplitude threshold; and discard detection signal of the at least one second detector subunit generated during at least the overshoot time span.

### FIELD OF THE INVENTION

The present invention relates to an interference-proof radiation detector for detection radiation interaction events of ionizing radiation and a method for interference-proof detection of radiation interaction events of ionizing radiation.

### BACKGROUND OF THE INVENTION

Radiation detectors comprising scintillators are widely used for detecting ionizing radiation, especially for detecting nuclear and/or radiological sources, in particular special nuclear material (SNM). The detection is performed by measuring the scintillation light generated when radiation interacts with the scintillating material of the scintillator.

At various screening locations such as border checkpoints, seaports, airports, urban centers, in the vicinity of nuclear facilities, import/export terminals etc., radiation portal monitors (RPMs) comprising such radiation detectors are used to screen objects such as containers, vehicles, persons etc. passing through the RPM. The RPMs are configured to detect ionizing radiation in order to alert to the presence of illicit transports of radiological and nuclear materials. In doing so, RPMs are capable to detect radiological threats such as shielded special nuclear materials (SNM). Further, the RPMs are required to discern SNM such as plutonium or highly enriched uranium from benign sources of radiation such as Naturally Occurring Radioactive Materials £ (NORM), medical isotopes, and natural backgrounds.

Besides passive systems used in RPMs for detecting for example gamma radiation and/or neutron sources, active systems using X-rays are known for non-intrusive inspection. While passive systems such as RPMs are used for interdicting radiological threats such as nuclear material, illicit radioactive sources and/or contaminated goods, active inspection systems emitting X-rays are typically used to record images of cargo and to interdict contraband by its shape in image. However, both systems may be deployed at e.g. ports and/or borders where X-rays from an active inspection system may interfere with an RPM causing malfunctioning and false alarms in the RPM. Interference issues are furthermore increasing due to high space constraints at e.g. ports. In order to at least partially mitigate the issues originating from interference, it has been attempted to spatially separate the active systems from the passive systems and/or to install additional Pb shielding to the active systems and/or the passive systems.

### SUMMARY OF THE INVENTION

It is therefore an object of the invention to provide an interference-proof radiation detector for detecting radiation interaction events of ionizing radiation and a method for interference-proof detection of radiation interaction events of ionizing radiation which at least partially improve the prior art and avoid at least part of the disadvantages of the prior art.

According to the present invention, this object is achieved by the features of the independent claims. In addition, further advantageous embodiments follow from the dependent claims and the description as well as the figures.

According to an aspect of the invention, the object is particularly achieved by an interference-proof radiation detector for detecting radiation interaction events of ionizing radiation, comprising a plurality of detector subunits, wherein each detector subunit comprises a scintillator and two or more continuously operable, solid-state silicon photomultiplier sensors configured to generate a detection signal responsive to scintillation light generated by the scintillator, the interference-proof radiation detector further comprising a signal processing circuit connected to the solid-state silicon photomultiplier sensors, the signal processing circuit being configured to: define a first signal amplitude threshold for a first detector subunit; in case a detection signal of at least one of the solid-state silicon photomultiplier sensors of the first detector subunit exceeds the first signal amplitude threshold: determine an overshoot time span during which the detection signal is above the first signal amplitude threshold; and discard detection signal of the solid-state silicon photomultiplier sensors of the at least one second detector subunit generated during at least the overshoot time span.

Using solid-state silicon photomultiplier sensors (SiPMs) provides the advantage that high voltage is not required for operating the SiPMs. For conventional radiation detectors using photomultiplier tubes (PMTs), high voltage supply is required for the operation of the PMTs. Accordingly, the radiation detectors are conventionally turned off if an X-ray pulse is emitted by a neighboring active inspection system in order to prevent damage to the PMTs. Thus, a blanking signal based on an analog signal from the active inspection system is typically used for the radiation detector or the radiation portal monitor, respectively, for turning off the high voltage supply of the PMTs during the X-ray pulse.

The SiPMs, in contrast, can continuously be operated without being prone to damage due to an X-ray pulse. Therefore, robustness of the radiation detector with regard to X-ray interference can be increased owing to the SiPMs. Further, complexity of the radiation detector can be reduced since a blanking signal based on an analog signal from the active inspection system, as used for conventional PMTs, is not required. Due to the continuous operation of the SiPMs, the radiation detector may furthermore continuously record data during an X-ray interference.

By using a plurality of detector subunits with a first detector subunit having a first signal amplitude threshold, a detector subunit dedicated for recognizing when the radiation detector is subject to a high dose, such as an X-ray pulse, can be provided. Further, one or more second detector subunits dedicated for recording radiation interaction events originating from the radiation detector and not from external interference, such as an X-ray pulse, can be provided. By determining an overshoot time span and discarding detection signal of the SiPMs of the at least one second detector subunits, interference-proof radiation detection can be enabled, since only radiation interaction events outside the overshoot time span or an interference period where interference may occur, are processed and output, respectively. The interference-proof radiation detection can thereby be provided without requiring an external signal e. g. for blanking any component of the radiation detector. The radiation detector can therefore provide interference-proof radiation detection by itself, i.e. independently, by providing a plurality of detector subunits for different purposes and a signal processing circuit discarding detection signal of the SiPMs of the at least one second detector subunit during at least the overshoot time span determined using the first signal amplitude threshold. The signal processing circuit may process and output, respectively, the detection signal of the SiPMs of the at least one second detector subunit which is not discarded and which represents detection signal of radiation interaction events not affected by interference. The signal processing circuit may comprise a digital signal processing circuit, comprising e.g. one or more of: a System-on-a-chip (SoC), a field-programmable gate array (FPGA), a microcontroller, an Application-specific integrated circuit (ASIC), configured to execute one or more of the steps as described in the present disclosure.

The signal processing circuit may comprise a plurality of subcircuits assigned to each detector subunit and configured to process the detection signal of each detector subunit.

The first signal amplitude threshold may be defined by the signal processing circuit by a calibration step where the first detector subunit is exposed to an X-ray pulse of an active inspection system and/or to a radiation interaction event to be detected by the radiation detector. The first signal amplitude threshold may also be defined by the signal processing circuit using predetermined threshold values for the configuration of the first detector subunit, e.g. including parameters such as scintillator size and/or type, SiPM properties such as gain etc.

In some embodiments, the signal processing circuit is configured to define a second signal amplitude threshold for at least one second detector subunit, wherein the signal processing circuit is configured to output detection signal from the at least one second detector subunit having an amplitude above the second signal amplitude threshold.

The second signal amplitude threshold may be defined to be above a signal amplitude of background noise, but below a signal amplitude of low-energy radiation interaction events. By defining a second signal amplitude threshold, the sensitivity of the radiation detector may therefore be improved.

In some embodiments, the first signal amplitude threshold is larger than the second signal amplitude threshold.

This may in particular be the case for embodiments where the detector subunits are comparably designed, for example having comparable sensitivities, comparable scintillators and/or comparable gain of the SiPMs.

In some embodiments, the first detector subunit exhibits a lower detection sensitivity than the at least one second detector subunit.

In some embodiments, the first detector subunit may exhibit a lower detection sensitivity than the at least one second detector subunit such that the first signal amplitude threshold may be lower than the second signal amplitude threshold.

In some embodiments, the signal processing circuit is configured to determine a coincidence window in which a majority of the solid-state silicon photomultiplier sensors of a detector subunit detects a rising edge of a detection signal.

By applying a coincidence window to identify radiation interaction events by a detection signal detected by a majority of the SiPMs of a detector subunit, signal-to-noise ratio of the detection signal can be improved.

In some embodiments, the signal processing unit is configured to define a first delay interval and to discard detection signal of the solid-state silicon photomultiplier sensors of the at least one second detector subunit generated during an interference period comprising the first delay interval and the overshoot time span, wherein the interference period starts by the first delay interval before the detection signal of at least one of the solid-state silicon photomultiplier sensors of the first detector subunit exceeds the first signal amplitude threshold.

The first delay interval may take into account the rise time of a detection signal generated due to an X-ray pulse and/or a first signal amplitude threshold being defined at a too high value. The first delay interval may be of the order of several 100 ns, for example between 100 and 500 ns.

The signal processing circuit may comprise a buffer configured to delay processing of the detection signal of the solid-state silicon photomultiplier sensors of the second detector subunit with respect to the detection signal of the solid-state silicon photomultiplier sensors of the first detector subunit by a further delay interval.

By delaying the processing of the detection signal of the second detector subunit, processing time of the first detector subunit may be taken into account. Starting of processing of the detection signal of the second detector subunit before a detection signal is identified whether it is affected by an X-ray pulse may thereby be avoided. The processing of the detection signal of the second detector subunit may be delayed with respect to the first detector subunit by the first delay interval.

In some embodiments, the signal processing unit is configured to define a second delay interval and to discard detection signal of the solid-state silicon photomultiplier sensors of the at least one second detector subunit generated during an interference period comprising the second delay interval and the overshoot time span, wherein the interference period ends by the second delay interval after the detection signal of at least one of the solid-state silicon photomultiplier sensors of the first detector subunit falls below the first signal amplitude threshold after having exceeded the first signal amplitude threshold.

The second delay interval may take into account a fall time of a detection signal generated due to an X-ray pulse and/or a first signal amplitude threshold being defined at a too high value. The second delay interval may be of the order of several 100 ns, for example between 100 and 500 ns.

In particular, the signal processing circuit may be configured to discard detection signal of the SiPMs of the at least one second detector subunit generated during an interference period comprising the first delay interval, the overshoot time span and second delay interval.

In some embodiments, the detector subunits each comprise a plastic scintillator tile, wherein the two or more solid-state silicon photomultiplier sensors of a detector subunit are arranged at a surface of the plastic scintillator tile of the detector subunit.

The plastic scintillator tiles may have a shape of a slab or a plate. The aspect ratio d/l and/or d/w of the plastic scintillator tiles, with d the thickness, l the length and w the width of the plastic scintillator tiles, is preferably below unity. The aspect ratio d/l and/or d/w may be for example between 0.01 and 0.2.

The plastic scintillator may comprise scintillator material made of polyvinyltoluene (PVT), PET, polystyrene or another scintillating material.

The SiPMs of a detector subunit may be arranged on a lateral surface or edge and/or on a top and/or bottom surface of the plastic scintillator tile of the detector subunit.

In some embodiments, the thickness of one or more of the plastic scintillator tiles is between 3-32 mm, preferably around 14 mm.

In some embodiments, the thickness of one or more of the plastic scintillator tiles is between 20 to 60 mm, preferably between 30 to 50 mm, particularly preferably around 40 mm.

In some embodiments, the area of one or more of the plastic scintillator tiles is between 10′000 mm² and 14′000 mm², preferably between 11′000 mm² and 13′000 mm², particularly preferably around 12′000mm².

In some embodiments, the area of one or more of the plastic scintillator tiles is between 100′000 mm² and 140′000 mm², preferably between 110′000 mm² and 130′000 mm², particularly preferably around 120′000 mm².

In some embodiments, a detector subunit comprises four SiPMs, wherein two SiPMs are arranged at a first edge of the plastic scintillator tile of the detector subunit and two SiPMs are arranged at a second, opposing edge of the plastic scintillator tile of the detector subunit.

In some embodiments, a detector subunit comprises two SiPMs, wherein one SiPM is arranged at a first edge of the plastic scintillator tile of the detector subunit and one SiPM is arranged at a second, opposing edge of the plastic scintillator tile of the detector subunit.

One or more of the plastic scintillator tiles may have a rectangular, square or other polygonal shape.

In some embodiments, the detector subunits are arranged such that a plastic scintillator tile of a detector subunit adjoins, preferably laterally, another plastic scintillator tile of a neighboring detector subunit.

The person skilled in the art understands that the plastic scintillator slabs may adjoin to each other without having direct contact to each other. For example, the interface between neighboring scintillator slabs may feature sufficient space to accommodate SiPMs, PCBs, optical grease, optical reflectors, wrapping etc.

The plastic scintillator tiles may have a thickness which is between one time and five times, preferably between one to two times, a side of the active area of a SiPM. Advantageously, this may allow the scintillation light to be transported to the SiPM by total internal reflection within the scintillator tiles.

The configuration and arrangement of the scintillator tiles therefore provides the advantage that light collection can be increased due to improved total internal reflection within the scintillators, in particular, compared to common plastic scintillator blocks.

The spaces between the SiPMs and the plastic scintillator tiles may be machined in a special way or filled with optical grease in order to increase the optical coupling.

The radiation detector may particularly be suitable to detect gamma radiation. However, detection capability of other radiation, such as alpha or beta radiation may alternatively or additionally be provided.

In some embodiments, the detector subunits are arranged such that at least two plastic scintillator tiles are vertically stacked on top of each other.

By vertically stacking scintillator tiles, a multi-layer radiation detector can be obtained such that the benefits of a thin scintillator which optimizes the light collection can be preserved. At the same time, a decreased efficiency of the thin scintillator for high energy radiation may be overcome due to the multi-layer structure.

In some embodiments, the detector subunits each comprise a neutron detector unit comprising a neutron conversion device. The neutron conversion device may comprise neutron reactive material configured to convert at least part of thermal and/or epi-thermal neutrons entering the radiation detector into neutron conversion products, such as light and/or charged particles. The neutron reactive material may comprise Li-6 or B-10.

The neutron conversion device may comprise a wavelength shifting device configured to shift short wavelength light to light of a wavelength to which the neutron conversion material is reflective or transparent. The wavelength shifting device may comprise a wavelength shifting material comprising Tetra Phenyl Butadiene (TPB), an organic wavelength shifter or an organo silicate compound.

In some embodiments, the neutron conversion device comprises a flexible neutron conversion foil comprising a neutron reactive material and configured to capture neutrons and to convert the captured neutrons to light and/or charged particles, wherein the neutron conversion foil is transparent to light produced in the scintillator.

In particular, the term “flexible” in the context of the neutron conversion foil shall be understood that the neutron conversion may be bendable and not rigid. The neutron conversion foil may be covered on a surface by a neutron conversion layer made of a neutron reactive material. The neutron conversion foil may be configured such that light originating from the conversion of neutrons, either directly from the neutron reactive material or from the scintillator, may pass through the neutron conversion foil. The neutron conversion foil may be covered on both surfaces by the neutron reactive material.

The neutron conversion layer may contain LiF and a suitable binder, preferably in a weight ratio between 1:1 and 15:1. The neutron conversion foil may have a thickness between 3 μm and 100 μm, preferably between 5 μm and 60 μm. The neutron conversion layer may have a thickness between 1 μm and 40 μm, preferably between 3 μm and 20 μm. The neutron conversion foil may comprise a substrate on which the neutron conversion layer is applied. The substrate may have a thickness between 2 μm and 20 μm. The substrate may be made of a PET foil transparent to light produced in the scintillator.

The neutron conversion foil may comprise a wavelength shifting layer configured to shift short wavelength light to light of a wavelength to which the neutron conversion foil is transparent. The wavelength shifting layer may have a thickness between 0.05 μm and 1 μm, preferably between 0.05 μm and 0.2 μm.

In some embodiments, the first detector subunit and the at least one second detector subunit are spatially separated at least in a horizontal direction.

Spatially separating the first detector subunit and the at least one second detector subunit at least in a horizontal direction provides the advantage that the radiation detector can be installed such that the first detector subunit is closer to a potential interference source, e.g. an X-ray inspection system, than the at least one second detector subunit and/or in direct line of sight to a potential interference source, e.g. an X-ray inspection system. Detection of an interference signal, such as an X-ray pulse, by the first detector subunit which it is designed for can therefore be facilitated while the at least one second detector subunits which are designed for detection of the radiation interaction events may be placed in a more remote position where at least partial shielding from direct illumination of the interference signal may be provided.

The first detector subunit and the at least one second detector subunit may additionally be spatially separated in a vertical direction.

The first detector subunit may exhibit a smaller size than the second detector subunit. In particular, the area of the scintillator or the total area of the scintillators of the first detector subunit may be smaller than the area of the scintillator or the total area of the scintillators of the second detector subunit. This may in particular be advantageous if the first detector subunit is installed closer to a potential interference source than the second detector subunit and/or in direct line of sight to a potential interference source.

The ratio of the area of the scintillator or the total area of the scintillators of the first detector subunit to the area of the scintillator or the total area of the scintillators of the second detector subunit may be between ½ and 1/10.

According to a further aspect, an interference-proof radiation detector for detecting radiation interaction events of ionizing radiation is provided, comprising a scintillator and two or more continuously operable solid-state silicon photomultiplier sensors configured to generate a detection signal responsive to scintillation light detected by the scintillator, the interference-proof radiation detector further comprising a processor connected to the solid-state silicon photomultiplier sensors, the processor being configured to: identify an interference signal caused by an interfering radiation using one or more of: shape, amplitude and frequency of pulses in the detection signal; determine an overshoot time span spanning at least a duration of the interference signal and a recovery time of at least one of the scintillators and/or the solid-state silicon photomultiplier sensors; discard detection signal of the solid-state silicon photomultiplier sensors generated during the overshoot time span.

The processor may therefore be configured to recognize interference by post-analyzing detection signal continuously recorded also during interference, especially X-ray interference. The processor may thereby exploit the characteristics of an interference signal which may typically differ from detection signal caused by radiation interaction events to be detected by the radiation detector.

By discarding detection signal of the SiPMs generated during the overshoot time span, the processor may effectively blank-out detection signal caused by interference radiation and, in particular, leave the remaining detection signal unaffected. The processor may then output detection signal of the SiPMs which is not discarded and which represents detection signal of radiation interaction events not affected by interference.

Thus, an interference-proof radiation detection can be enabled since only radiation interaction events outside the overshoot time span or an interference period where interference may occur, are output by the processor. The interference-proof radiation detection can thereby be provided without requiring an external signal e.g. a blanking signal for blanking any component of the radiation detector. The radiation detector can therefore provide interference-proof radiation detection by itself, by identifying an interference signal caused by an interfering radiation using one or more of: shape, amplitude and frequency of pulses in the detection signal and discarding detection signal of the solid-state silicon photomultiplier sensors generated during the overshoot time span spanning at least a duration of the interference signal and a recovery time of at least one of the scintillators and/or the solid-state silicon photomultiplier sensors.

The scintillator may comprise one or more plastic scintillator tiles, wherein the two or more solid-state silicon photomultiplier sensors may be arranged at a surface and/or edge of the plastic scintillator tiles. The plastic scintillator tiles may be designed as described in the present disclosure. The radiation detector may comprise a neutron detector unit, as described in the present disclosure.

In some embodiments, the processor is configured to identify an interference signal caused by an interfering radiation using one or more of: shape, amplitude and frequency of pulses in the detection signal.

In some embodiments, the processor is configured to identify an interference signal caused by an interfering radiation by applying a pulse threshold, wherein the pulse threshold is preferably two, three or four times a height of an average pulse in the detection signal generated responsive to a radiation interaction event without interference.

In some embodiments, the processor is configured to identify an interference signal caused by an interfering radiation using the shape of pulses in the detection signal by selecting pulses with a saturated detection signal.

The interference-proof radiation detector may therefore independently recognize an interference signal using the processor which is configured to analyze the detection signal generated continuously by the SiPMs.

According to a further aspect, an interference-proof radiation detection system is provided, comprising an interference-proof radiation detector according to the present disclosure and an active X-ray inspection system configured to emit X-rays for scanning cargo, wherein the active X-ray inspection system is arranged next to the interference-proof radiation detector.

The interference-proof radiation detection system therefore provides the advantage that simultaneous passive radiation detection and active inspection may be performed while minimizing or avoiding interference between the passive radiation detector and the active inspection system.

In some embodiments of the interference-proof radiation detection system, the interference-proof radiation detector and the active X-ray inspection system are electrically decoupled from each other.

In particular, it may not be necessary to connect the interference-proof radiation detector and the active X-ray inspection system by cable, since transmission of an analog blanking signal from the X-ray inspection system to the radiation detector may not be required, as described above. Thus, the interference-proof radiation detector and the active X-ray inspection system may be electrically decoupled from each other in the sense that a wired or wireless signal communication line between the interference-proof radiation detector and the active X-ray inspection system may not be required and therefore be absent.

In some embodiments of the interference-proof radiation detection system, the first detector subunit and the at least one second detector subunit are spatially separated, wherein the first detector subunit is arranged closer to the active X-ray inspection system than the at least one second detector subunit and/or in direct line of sight of the active X-ray inspection system.

Detection of an interference signal, such as an X-ray pulse, by the first detector subunit for which it is designed for can therefore be facilitated while the at least one second detector subunits which are designed for detection of the radiation interaction events may be placed in a more remote position where at least partial shielding from direct illumination of the interference signal may be provided.

The first detector subunit may exhibit a smaller size than the second detector subunit. In particular, the area of the scintillator or the total area of the scintillators of the first detector subunit may be smaller than the area of the scintillator or the total area of the scintillators of the second detector subunit. This may in particular be advantageous if the first detector subunit is installed closer to a potential interference source than the second detector subunit and/or in direct line of sight to a potential interference source.

The ratio of the area of the scintillator or the total area of the scintillators of the first detector subunit to the area of the scintillator or the total area of the scintillators of the second detector subunit may be between ½ and 1/10.

In some embodiments of the interference-proof radiation detection system, the interference-proof radiation detector may be configured to receive an X-ray veto signal generated by the active X-ray inspection system. The active X-ray inspection system may be configured to generate an X-ray veto signal if an accelerator of the active X-ray inspection system is on. The interference-proof radiation detector may be configured to apply a gating or blanking signal to the second detector subunit when receiving the X-ray veto signal pausing the second detector subunit from recording a detection signal.

According to a further aspect, a method for interference-proof detection of radiation interaction £ events of ionizing radiation is provided, the method comprising the steps of: providing an interference-proof radiation detector according to the present disclosure; defining by the signal processing circuit a first signal amplitude threshold for the first detector subunit; in case a detection signal of at least one of the solid-state silicon photomultiplier sensors of the first detector subunit exceeds the first signal amplitude threshold: determining by the signal processing circuit an overshoot time span during which the detection signal is above the first signal amplitude threshold; and discarding by the signal processing circuit detection signal of the solid-state silicon photomultiplier sensors of the at least one second detector subunit during at least the overshoot time span; in case a detection signal of the solid-state silicon photomultiplier sensors of the first detector subunit is below the first signal amplitude threshold: processing by the signal processing circuit the detection signal of the at least one second detector subunit.

In some embodiments of the method, the signal processing unit defines a second signal amplitude threshold for at least one second detector subunit, wherein the first signal amplitude threshold is preferably larger than the second signal amplitude threshold.

According to a further aspect, a method for interference-proof detection of radiation interaction events of ionizing radiation is provided, the method comprising the steps of: providing an interference-proof radiation detector according to the present disclosure; generating a detection signal by the interference-proof radiation detector; identifying by the processor an interference signal caused by an interfering radiation using one or more of: shape, amplitude and frequency of pulses in the detection signal; determining by the processor an overshoot time span at least spanning a duration of the interference signal and a recovery time of at least one of the scintillators and/or the solid-state silicon photomultiplier sensors; discarding by the processor detection signal of the solid-state silicon photomultiplier sensors generated during the overshoot time span.

In particular, the processor may generate a rectified detection signal by subtracting detection signal of the solid-state silicon photomultiplier sensors generated during the overshoot time span from the detection signal generated by the interference-proof radiation detector and output the rectified detection signal.

In some embodiments of the method, the solid-state silicon photomultiplier sensors are continuously operated.

According to a further aspect, a computer program product is provided, comprising computer program code for interference-proof detection of radiation interaction events of ionizing radiation using an interference-proof radiation detector comprising a scintillator and two or more continuously operable solid-state silicon photomultiplier sensors configured to generate a detection signal responsive to scintillation light detected by the scintillator, the computer program code configured to control a processor of the interference-proof radiation detector connected to the solid-state silicon photomultiplier sensors such that the processor executes the steps of: receiving a detections generated by the interference-proof radiation detector; identifying an interference signal caused by an interfering radiation using one or more of: shape, amplitude and frequency of pulses in the detection signal; determining an overshoot time span spanning a duration of the interference signal and a recovery time of at least one of the scintillators and/or the solid-state silicon photomultiplier sensors; generating a rectified detection signal by subtracting detection signal of the solid-state silicon photomultiplier sensors generated during the overshoot time span from the detection signal generated by the interference-proof radiation detector; outputting the rectified detection signal.

According to a further aspect, a non-transitory computer-readable medium having stored thereon the computer program product according to the present disclosure, is provided.

According to a further aspect, a computer-implemented method for interference-proof detection of radiation interaction events of ionizing radiation using an interference-proof radiation detector comprising a scintillator and two or more continuously operable solid-state silicon photomultiplier sensors configured to generate a detection signal responsive to scintillation light detected by the scintillator, is provided, the method comprising a processor of the interference-proof radiation detector connected to the solid-state silicon photomultiplier sensors executing the steps of: receiving a detection signal generated by the interference-proof radiation detector; identifying an interference signal caused by an interfering radiation using one or more of: shape, amplitude and frequency of pulses in the detection signal; determining an overshoot time span spanning a duration of the interference signal and a recovery time of at least one of the scintillators and/or the solid-state silicon photomultiplier sensors; generating a rectified detection signal by subtracting detection signal of the solid-state silicon photomultiplier sensors generated during the overshoot time span from the detection signal generated by the interference-proof radiation detector; outputting the rectified detection signal.

### BRIEF DESCRIPTION OF THE DRAWINGS

The present invention will be explained in more detail, by way of exemplary embodiments, with reference to the schematic drawings, in which:

FIG. 1 shows an embodiment of an interference-proof radiation detection system;

FIG. 2 shows an embodiment of a detector subunit comprising four solid-state silicon photomultiplier sensors and a signal processing circuit;

FIG. 3 shows an exemplary signal recorded by a detector subunit as the one shown in FIG. 2;

FIG. 4 shows a flow block diagram of an interference-proof radiation detection using a radiation detector with detector subunits;

FIG. 5a-b show a measurement of radiation interaction events without X-ray interference and a measurement of radiation interaction events with X-ray interference;

FIG. 6 shows a close-up to a measurement of radiation interaction events with an interference signal caused by an X-ray pulse;

FIG. 7a-c show count rates of a measurement of radiation interaction events without X-ray interference, a measurement of radiation interaction events with X-ray interference and count rates after interference signal has been removed from the measurement of radiation interaction events with X-ray interference.

### DETAILED DESCRIPTION OF EXEMPLARY EMBODIMENTS

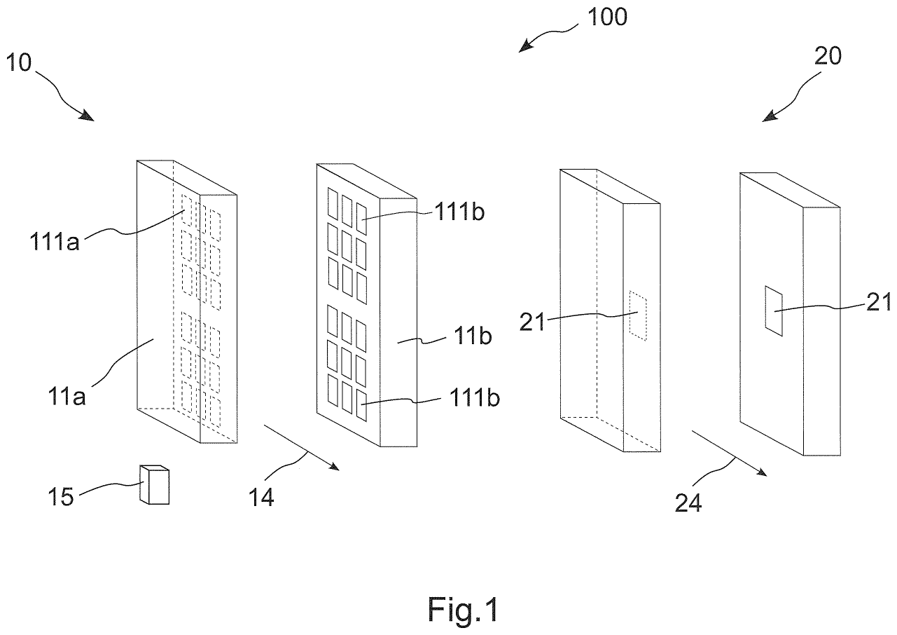

FIG. 1 shows an embodiment of an interference-proof radiation detection system 100 comprising an interference-proof radiation detector in the form of a radiation portal monitor 10. The radiation portal monitor 10 (RPM) comprises two pillars with interference-proof radiation detectors 11a, 11b. The pillars with interference-proof radiation detectors 11a, 11b define an RPM passage 14 where a moving radiation source passes through in objects to be scanned such as trucks or other traffic. Besides the interference-proof radiation detectors 11a and 11b, the pillars comprise ancillary detectors such as occupancy sensors and instrumentation. The interference-proof radiation detectors 11a and 11b each comprise arrays of plastic scintillator tiles 111a, 111b, forming a panel radiation detector, as described for example in WO 2020/208203 A1, the contents of which are included herein by reference. Two or more solid-state silicon photomultiplier sensors (SiPMs) are arranged at a surface or edge, respectively, of each plastic scintillator tile 111a, 111b. One or more of the plastic scintillator tiles 111a or 111b may be part of one or more detector subunits. The RPM 10 may further comprise neutron detectors (not shown) with one or more flexible neutron conversion foils as neutron conversion devices. The RPM 10 comprises one or more signal processing circuits or processors, as schematically indicated by a box 15.

The interference-proof radiation detection System 100 comprises an active X-ray inspection system 20 configured to emit X-rays by one or more X-ray sources 21 for scanning cargo passing the passage 24. The active X-ray inspection system 20 is arranged next to the RPM 10 and therefore, next to the interference-proof radiation detectors 11a, 11b. The radiation detectors 11a, 11b are not wire-connected to the X-ray inspection system 20. One of the plastic scintillator tiles 111b is part of a first detector subunit and therefore closer to the X-ray inspection system than second detector subunits which comprise one or more plastic scintillator tiles 111a. In some embodiments, however, one of the plastic scintillator tiles 111a may be part of a first detector subunit.

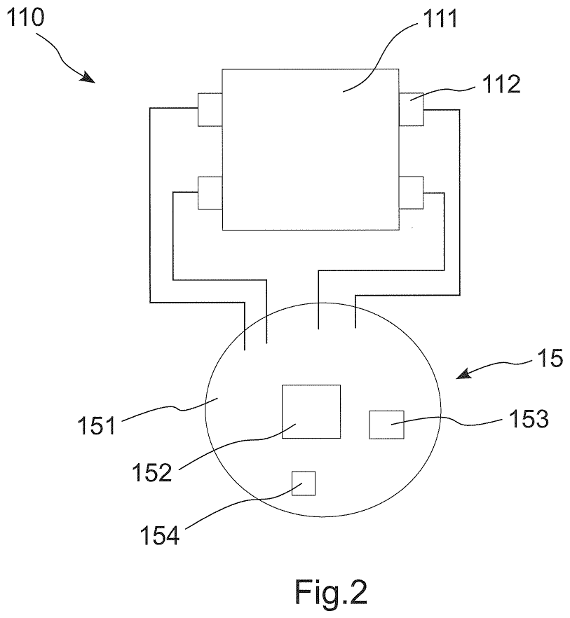

FIG. 2 shows an embodiment of a detector subunit 110 comprising a plastic scintillator tile 111 made of PVT and four SiPMS 112 arranged at two edges of the plastic scintillator tile 111. The SiPMs 112 are pairwise arranged on opposing edges of the plastic scintillator tile 111 and wire-connected to a signal processing circuit 15. The signal processing circuit 15 may be a joint signal processing circuit for a plurality of detector subunits or a signal processing circuit dedicated for the detector subunit 110 and therefore part of the detector subunit 110. The signal processing circuit 15 comprises a PCB 151 on which there is arranged a Field Programmable Gate Array (FPGA) 152 comprising a coincidence logic and a time-over-threshold (TOT) counter. The signal processing circuit 15 further comprises a microcontroller 153 configured for communication and postprocessing of the detection signal of the SiPMs 112. The signal processing circuit 15 further comprises an interface 154 configured for connection with a processor, for example of a data processing unit. The detector subunit 110 may be a first detector subunit configured to recognize when the radiation detector is subject to an X-ray pulse. Alternatively, the detector subunit 110 may be a second detector subunit configured to record radiation interaction events originating from the radiation detector and not from external interference, such as an X-ray pulse.

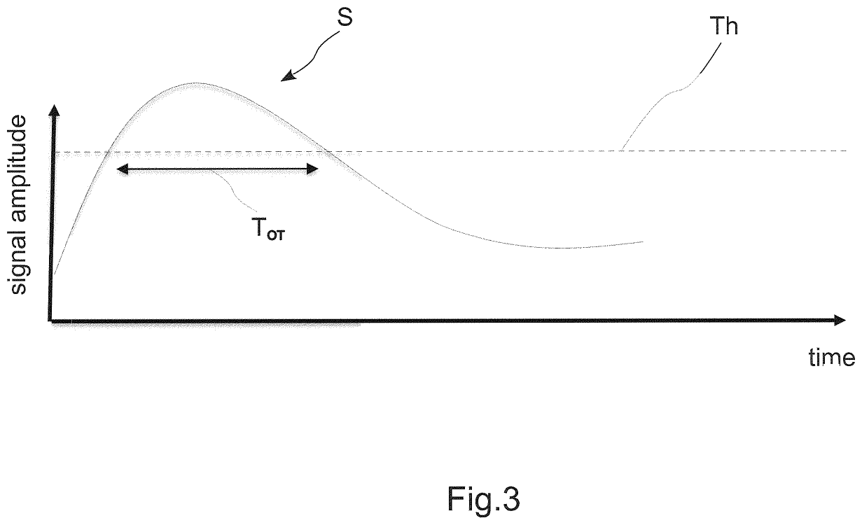

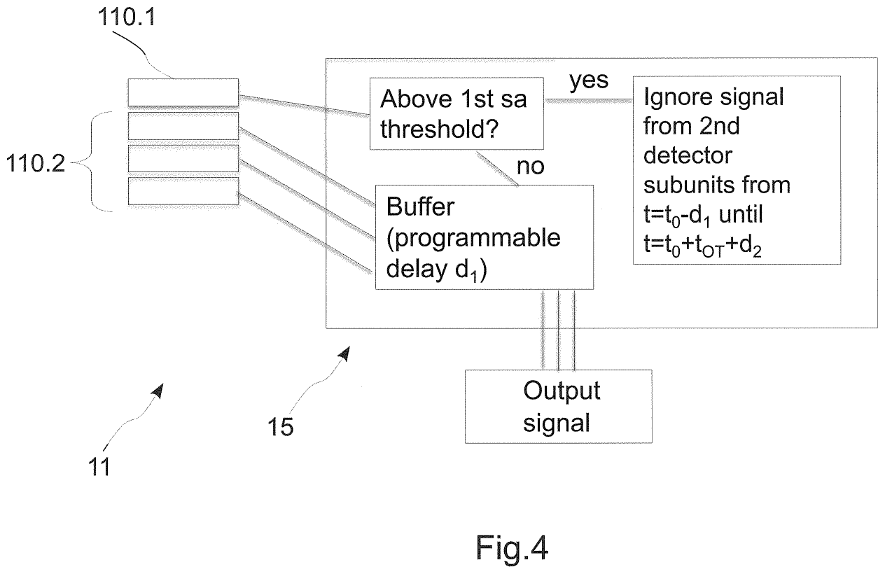

FIG. 3 shows an exemplary detection signal S recorded by a detector subunit 110 as the one shown in FIG. 2, where the detector subunit is configured as a first detector subunit dedicated for recognizing an interference signal from an X-ray inspection system, such as the one shown in FIG. 1. A first signal amplitude threshold Th, as defined by the signal processing unit is indicated by the dashed line. The detection signal S recorded by the first detector subunit is an example of a detection signal when the X-ray inspection system emits an X-ray pulse such that the detection signal S of the SiPMs of the first detector subunit exceeds the first signal amplitude threshold Th during an overshoot time span T_{OT}, as determined by the TOT counter of the signal processing circuit. Due to the detection signal S recorded by the first detector subunit, the signal processing circuit discards detection signal of the one or more second detector subunits of the radiation detector generated during the overshoot time span T_{OT}. In some embodiments, the signal processing circuit discards detection signal of the one or more second detector subunits generated during the overshoot time span T_{OT} and one or more delay intervals, as will be described for example in connection with FIG. 4.

FIG. 4 shows a flow block diagram of an interference-proof radiation detection using a radiation detector 11 with a first detector subunit 110.1 and a second detector subunit 110.2. The detector subunits 110.1 and 110.2 may be designed as the one shown in FIG. 2. In case the signal processing circuit 15 recognizes that a detection signal of at least one of the SiPMs of the first detector subunit 110.1 exceeds the first signal amplitude threshold (“sa threshold” in FIG. 4), the signal processing circuit 15 discards detection signal of the SiPMs of the second detector subunits 110.2 generated during an interference period d₁+t_{OT}+d₂, where d₁ is a first delay interval, d₂ is a second delay interval and tor is the overshoot time span determined by the signal processing circuit. t₀ is the point in time where the detection signal of at least one of the SiPMs of the first detector subunit 110.1 exceeds the first signal amplitude threshold. The first delay interval di takes into account the rising time of a detection signal generated due to an X-ray pulse and/or the first signal amplitude threshold being defined at a too high value. The first delay interval is programmable and of the order of several 100 ns, for example between 100 and 500 ns. The second delay interval d₂ takes into account a fall time of a detection signal generated due to an X-ray pulse and/or a first signal amplitude threshold being defined at a too high value. The second delay interval is programmable and of the order of several 100 ns, for example between 100 and 500 ns.

The signal processing circuit 15 comprises a buffer configured to delay processing of the detection signal of the SiPMs of the second detector subunit 110.2 with respect to the detection signal of the SiPMs of the first detector subunit 110.1 by the first delay interval di. Starting of processing of the detection signal of the second detector subunit 110.2 before a detection signal is identified whether it is affected by an X-ray pulse may thereby be avoided. In case the signal processing circuit 15 recognizes that a detection signal of the SiPMs of the first detector subunit 110.1 is below the first signal amplitude threshold, the detection signal of the of the second detector subunits 110.2 is processed and output.

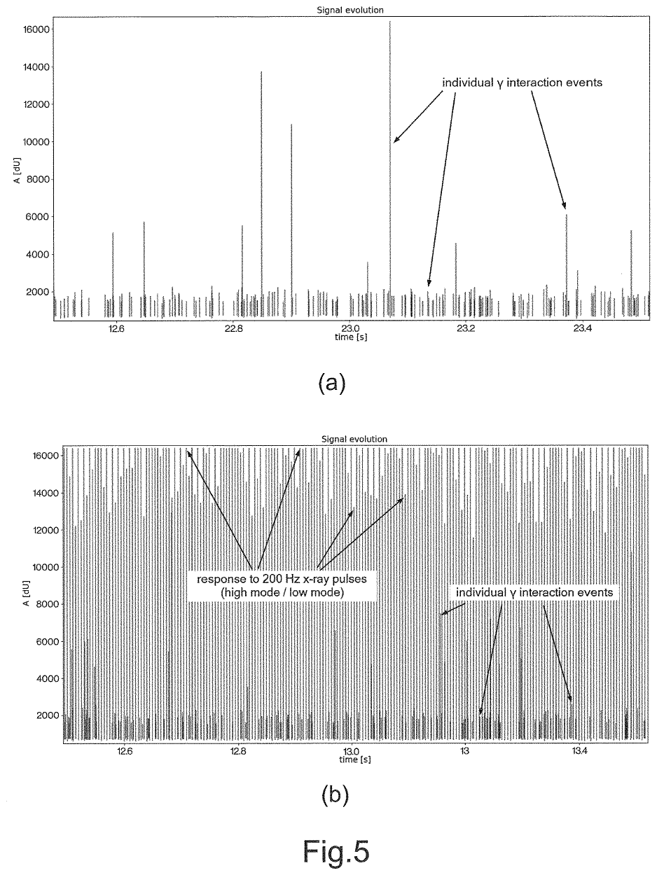

FIG. 5a shows a measurement of radiation interaction events without an X-ray interference signal. The horizontal axis is the time axis in seconds. The vertical axis is the amplitude in arbitrary units. The measurement shows a plurality of individual gamma radiation interaction events detected by the radiation detector, such as the one shown in FIG. 1.

FIG. 5b shows a measurement of radiation interaction events with an X-ray interference signal, showing a close-up with respect to the time axis. The X-ray interference signal is due to a response to 200 Hz X-ray pulses generated in an X-ray inspection system, such as the one shown in FIG. 1, where the X-ray inspection system generates both high energy (high mode) and low energy (low mode) X-ray pulses. It can be recognized that the individual gamma radiation interaction events are buried within the X-ray pulses.

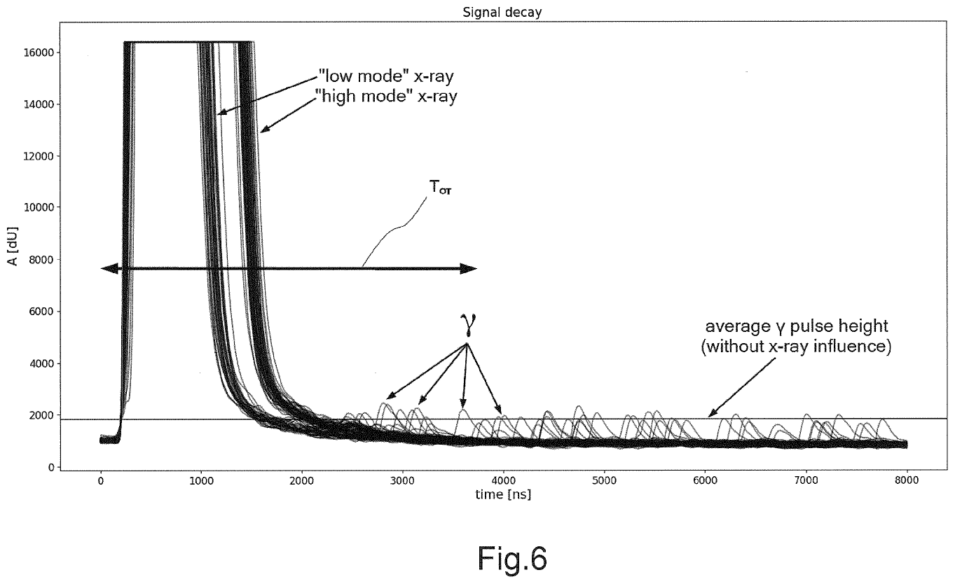

FIG. 6 shows a close-up to a measurement of gamma radiation interaction events with an interference signal caused by a high energy (high mode) and a low energy (low mode) X-ray pulse. Next to the interference signal, a plurality of pulses of gamma radiation interaction events are recognizable in the detection signal. A processor of the radiation detector identifies the interference signal by the shape of the high mode and low mode pulse and/or the saturation in the detection signal due to the high mode and low mode pulse. An overshoot time span Tor is determined spanning the duration of the interference signal and a recovery time of the plastic scintillators of the order a few μs. The processor may also identify the interference signal by applying a pulse threshold being two, three or four times the height of the average gamma pulse height without X-ray interference, as indicated in FIG. 6. Using the overshoot time span Tor, the processor discards detection signal generated during the overshoot time span Tor and outputs the detection signal outside of the overshoot time span Tor comprising the interference-free pulses of gamma radiation interaction events.

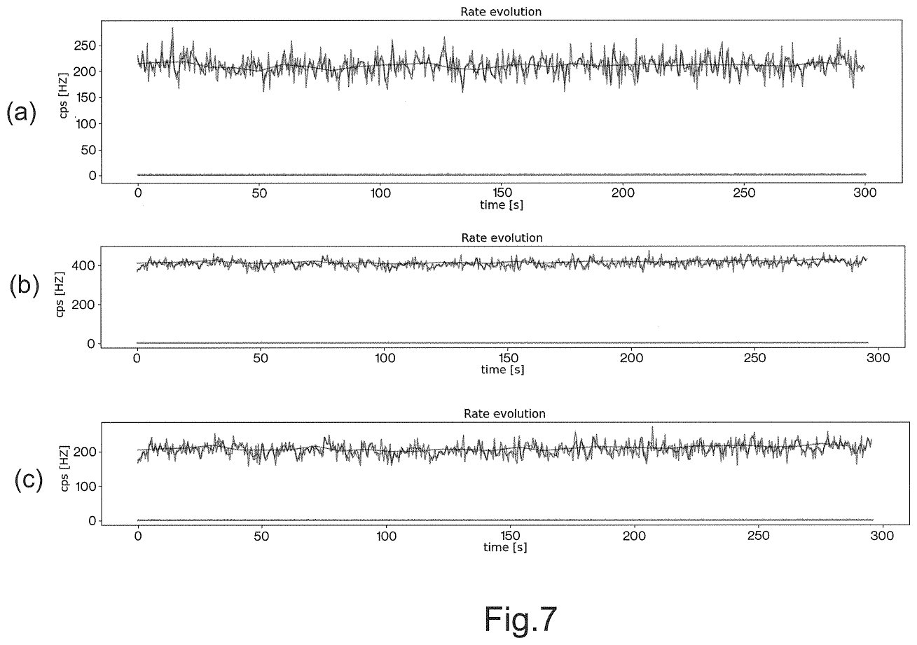

FIG. 7a shows a count rate trace of a measurement of radiation interaction events of a gamma radiation source without X-ray interference.

FIG. 7b shows a count race trace of a measurement of radiation interaction events of the gamma radiation source with X-ray interference. It can be recognized that the count rate is significantly increased compared to the count rate as shown in FIG. 7a.

FIG. 7c shows a count rate trace after the detection signal generated during the overshoot time span due to an interference signal has been discarded from the measurement of radiation interaction events with X-ray interference, as described in connection with FIG. 6. It can be recognized that the count rate is recovered to the range as shown in FIG. 7a. Therefore, counts due to X-ray interference have been removed by the processor.

1. An interference-proof radiation detector (10, 11a, 11b) for detecting radiation interaction events of ionizing radiation, comprising a plurality of detector subunits (110), wherein each detector subunit comprises a scintillator (111a, 111b, 111) and two or more continuously operable, solid-state silicon photomultiplier sensors (112) configured to generate a detection signal responsive to scintillation light generated by the scintillator, the interference-proof radiation detector further comprising a signal processing circuit (15) connected to the solid-state silicon photomultiplier sensors, the signal processing circuit being configured to:
define a first signal amplitude threshold (Th) for a first detector subunit;
in case a detection signal of at least one of the solid-state silicon photomultiplier sensors of the first detector subunit exceeds the first signal amplitude threshold:
determine an overshoot time span (T_{OT}) during which the detection signal is above the first signal amplitude threshold; and
discard detection signal of the solid-state silicon photomultiplier sensors of at least one second detector subunit generated during at least the overshoot time span.

2. The interference-proof radiation detector (10, 11a, 11b) according to claim 1, wherein the signal processing circuit (15) is configured to define a second signal amplitude threshold for the at least one second detector subunit, wherein the signal processing circuit is configured to output detection signal from the at least one second detector subunit having an amplitude above the second signal amplitude threshold.

3. The interference-proof radiation detector (10, 11a, 11b) according to claim 2, wherein the first signal amplitude threshold (Th) is larger than the second signal amplitude threshold.

4. The interference-proof radiation detector (10, 11a, 11b) according to claim 1, wherein the signal processing circuit (15) is configured to determine a coincidence window in which a majority of the solid-state silicon photomultiplier sensors (112) of a detector subunit (110) detects a rising edge of a detection signal.

5. The interference-proof radiation detector (10, 11a, 11b) according to claim 1, wherein the signal processing unit (15) is configured to define a first delay interval (d₁) and to discard detection signal of the solid-state silicon photomultiplier sensors of the at least one second detector subunit generated during an interference period comprising the first delay interval and the overshoot time span (T_{OT}), wherein the interference period starts by the first delay interval before the detection signal of at least one of the solid-state silicon photomultiplier sensors of the first detector subunit exceeds the first signal amplitude threshold (Th).

6. The interference-proof radiation detector (10, 11a, 11b) according to claim 1, wherein the signal processing unit (15) is configured to define a second delay interval (d₂) and to discard detection signal of the solid-state silicon photomultiplier sensors of the at least one second detector subunit generated during an interference period comprising the second delay interval and the overshoot time span (T_{PT}), wherein the interference period ends by the second delay interval after the detection signal of at least one of the solid-state silicon photomultiplier sensors of the first detector subunit falls below the first signal amplitude threshold after having exceeded the first signal amplitude threshold (Th).

7. The interference-proof radiation detector (10, 11a, 11b) according to claim 1, wherein the detector subunits (110) each comprise a plastic scintillator tile (111, 111a, 111b), wherein the two or more solid-state silicon photomultiplier sensors (112) of a detector subunit are arranged at a surface of the plastic scintillator tile of the detector subunit.

8. The interference-proof radiation detector (10, 11a, 11b) according to claim 7, wherein the detector subunits (110) are arranged such that a plastic scintillator tile (111, 111a, 111b) of a detector subunit adjoins, preferably laterally, another plastic scintillator tile of a neighboring detector subunit.

9. The interference-proof radiation detector according to claim 7, wherein the detector subunits are arranged such that at least two plastic scintillator tiles are vertically stacked on top of each other.

10. The interference-proof radiation detector (10, 11a, 11b) according to claim 1, one wherein the detector subunits each comprise a neutron detector unit comprising a neutron conversion device.

11. The interference-proof radiation detector (10, 11a, 11b) according to claim 10, wherein the neutron conversion device comprises a flexible neutron conversion foil comprising a neutron reactive material and configured to capture neutrons and to convert the captured neutrons to light and/or charged particles, wherein the neutron conversion foil is transparent to light produced in the scintillator.

12. The interference-proof radiation detector (10, 11a, 11b) according to claim 1, wherein the first detector subunit and the at least one second detector subunit are spatially separated at least in a horizontal direction.

13. An interference-proof radiation detector (10, 11a, 11b) for detecting radiation interaction events of ionizing radiation, comprising a scintillator (111a, 111b, 111) and two or more continuously operable solid-state silicon photomultiplier sensors (112) configured to generate a detection signal responsive to scintillation light detected by the scintillator, the interference-proof radiation detector further comprising a processor (15) connected to the solid-state silicon photomultiplier sensors, the processor being configured to:
identify an interference signal caused by an interfering radiation using one or more of: shape, amplitude and frequency of pulses in the detection signal;
determine an overshoot time span (T_{OT}) spanning at least a duration of the interference signal and a recovery time of at least one of the scintillators and/or the solid-state silicon photomultiplier sensors;
discard detection signal of the solid-state silicon photomultiplier sensors generated during the overshoot time span.

14. The interference-proof radiation detector (10, 11a, 11b) according to claim 13, wherein the processor (15) is configured to identify an interference signal caused by an interfering radiation by applying a pulse threshold, wherein the pulse threshold is preferably two, three or four times a height of an average pulse in the detection signal generated responsive to a radiation interaction event without interference.

15. The interference-proof radiation detector (10, 11a, 11b) according to claim 13, wherein the processor (15) is configured to identify an interference signal caused by an interfering radiation using the shape of pulses in the detection signal by selecting pulses with a saturated detection signal.

16. An interference-proof radiation detection system (100) comprising the interference-proof radiation detector (10, 11a, 11b) according to claim 1, and an active X-ray inspection system (20) configured to emit X-rays for scanning cargo, wherein the active X-ray inspection system is arranged next to the interference-proof radiation detector.

17. The interference-proof radiation detection system (100) according to claim 16, wherein the interference-proof radiation detector (10, 11a, 11b) and the active X-ray inspection system (20) are electrically decoupled from each other.

18. The interference-proof radiation detection system (100) according to claim 16, wherein the first detector subunit and the at least one second detector subunit are spatially separated, wherein the first detector subunit is arranged closer to the active X-ray inspection system than the at least one second detector subunit.

19. A method for interference-proof detection of radiation interaction events of ionizing radiation, the method comprising the steps of:
providing an interference-proof radiation detector (10, 11a, 11b) according to claim 1;
defining by the signal processing circuit (15) a first signal amplitude threshold (Th) for the first detector subunit;
in case a detection signal of at least one of the solid-state silicon photomultiplier sensors (112) of the first detector subunit exceeds the first signal amplitude threshold:
determining by the signal processing circuit an overshoot time span (T_{OT}) during which the detection signal is above the first signal amplitude threshold; and
discarding by the signal processing circuit detection signal of the solid-state silicon photomultiplier sensors of the at least one second detector subunit during at least the overshoot time span;
in case a detection signal of the solid-state silicon photomultiplier sensors of the first detector subunit is below the first signal amplitude threshold:
processing by the signal processing circuit the detection signal of the at least one second detector subunit.

20. The method according to claim 19, comprising the signal processing unit (15) defining a second signal amplitude threshold for at least one second detector subunit, wherein the first signal amplitude threshold is preferably larger than the second signal amplitude threshold.

21. A method for interference-proof detection of radiation interaction events of ionizing radiation, the method comprising the steps of:
providing an interference-proof radiation detector (10, 11a, 11b) according to claim 13;
generating a detection signal by the interference-proof radiation detector;
identifying by the processor (15) an interference signal caused by an interfering radiation using one or more of: shape, amplitude and frequency of pulses in the detection signal;
determining by the processor an overshoot time span (T_{OT}) at least spanning a duration of the interference signal and a recovery time of at least one of the scintillators (111, 111a, 111b) and/or the solid-state silicon photomultiplier sensors (112);
discarding by the processor detection signal of the solid-state silicon photomultiplier sensors generated during the overshoot time span.

22. The method according to claim 20, wherein the solid-state silicon photomultiplier sensors (112) are continuously operated.

23. A computer program product comprising computer program code for interference-proof detection of radiation interaction events of ionizing radiation using an interference-proof radiation detector (10, 11a, 11b) comprising a scintillator (111, 111a, 111b) and two or more continuously operable solid-state silicon photomultiplier sensors (112) configured to generate a detection signal responsive to scintillation light detected by the scintillator, the computer program code configured to control a processor (15) of the interference-proof radiation detector connected to the solid-state silicon photomultiplier sensors such that the processor executes the steps of:
receiving a detection signal generated by the interference-proof radiation detector;
identifying an interference signal caused by an interfering radiation using one or more of: shape, amplitude and frequency of pulses in the detection signal;
determining an overshoot time span (T_{OT}) spanning a duration of the interference signal and a recovery time of at least one of the scintillators and/or the solid-state silicon photomultiplier sensors;
generating a rectified detection signal by subtracting detection signal of the solid-state silicon photomultiplier sensors generated during the overshoot time span from the detection signal generated by the interference-proof radiation detector;
outputting the rectified detection signal.

24. A non-transitory computer-readable medium having stored thereon the computer program product according to claim 23.

25. A computer-implemented method for interference-proof detection of radiation interaction events of ionizing radiation using an interference-proof radiation detector (10, 11a, 11b) comprising a scintillator (111, 111a, 111b) and two or more continuously operable solid-state silicon photomultiplier sensors (112) configured to generate a detection signal responsive to scintillation light detected by the scintillator, the method comprising a processor (15) of the interference-proof radiation detector connected to the solid-state silicon photomultiplier sensors executing the steps of:
receiving a detection signal generated by the interference-proof radiation detector;
identifying an interference signal caused by an interfering radiation using one or more of: shape, amplitude and frequency of pulses in the detection signal;
determining an overshoot time span (T_{OT}) spanning a duration of the interference signal and a recovery time of at least one of the scintillators and/or the solid-state silicon photomultiplier sensors;
generating a rectified detection signal by subtracting detection signal of the solid-state silicon photomultiplier sensors generated during the overshoot time span from the detection signal generated by the interference-proof radiation detector;
outputting the rectified detection signal.
